(19) United States
(12) Patent Application Publication
(10) Pub. No.: US 2013/0054847 A1
(43) Pub. Date: Feb. 28, 2013

(54) SEMICONDUCTOR CHIP AND SEMICONDUCTOR SYSTEM COMPRISING SAME

(71) Applicants: Seong Won Cho, Seoul (KR); Young Goan Kim, Seoul (KR)

(72) Inventors: Seong Won Cho, Seoul (KR); Young Goan Kim, Seoul (KR)

(73) Assignee: NOVACHIPS CO., LTD., Seongnam-si (KR)

(21) Appl. No.: 13/583,684

(22) PCT Filed: May 12, 2011
(86) PCT No.: PCT/KR11/03508

§ 371 Date: Sep. 10, 2012

(30) Foreign Application Priority Data
May 14, 2010 (KR) 10-2010-0045649

(51) Int. Cl. G06F 3/00

(52) U.S. Cl. 710/38

(57) ABSTRACT

A semiconductor chip and a semiconductor system comprising the chip. The semiconductor system comprises: a serial advanced technology attachment (SATA) host; a plurality of SATA devices which receive data from the SATA host and stores the received data, or transmit the stored data to the SATA host; and a semiconductor chip which controls a data-transceiving operation between the SATA host and the SATA devices. The semiconductor chip and the semiconductor system have merits in that the semiconductor chip may be connected to a plurality of devices without being limited by the number of host channels of the semiconductor chip, while preventing an increase in the size of a host.

### TECHNICAL FIELD

The present invention relates to a semiconductor chip and a semiconductor system including the same, and more particularly to a semiconductor chip, to which a required number of devices may be connected without being limited by the number of host channels, and a semiconductor system including the same.

### BACKGROUND ART

As it has become usual to carry out a portable electronic device, the number of SATA devices capable of being connected to an electronic device including a SATA host has increased. However, in order to connect the SATA devices to an electronic device which is a host, the electronic device should include the same number of SATA host channels as the number of the SATA devices to be connected. However, an increase in the number of the SATA host channels may cause a problem in the situation requiring miniaturization of the electronic device. Also, the same problem may exist in a USB host.

### DETAILED DESCRIPTION OF THE INVENTION

### Technical Problem

Therefore, an aspect of present invention is to provide a semiconductor chip, to which a required number of devices may be connected without being limited by the number of host channels, and a semiconductor system including the same.

### Technical Solution

In accordance with an aspect of the present invention, there is provided a semiconductor system including: a serial advanced technology attachment (SATA) host; a plurality of SATA devices for receiving data from the SATA host and storing the data, or transmitting the stored data to the SATA host; and a semiconductor chip for controlling data transmission and reception between the SATA host and the SATA devices, the semiconductor chip including: a SATA host interface connected to channels of the SATA host through one or more connectors to perform interfacing data transmission and reception with the SATA host; a plurality of device interfaces for interfacing data transmission and reception with the plurality of SATA devices; and a SATA port multiplier for, when the number of the plurality of SATA devices connected to the device interfaces is much more than the number of the channels of the SATA host, controlling allocation of the channels of the SATA host for the plurality of SATA devices connected to the device interfaces.

Preferably, the semiconductor chip is a system-on-chip (SoC) storage controller.

In accordance with an aspect of the present invention, there is provided a semiconductor chip including: a SATA host interface for interfacing data transmission and reception with the SATA host by being connected to channels of a SATA host through a connector; a plurality of device interfaces for receiving data from the SATA host and storing the data, or interfacing data transmission and reception with a plurality of SATA devices for transmitting the stored data to the SATA host; and a SATA port multiplier for, when the number of the plurality of SATA devices connected to the device interfaces is more than the number of the channels of the SATA host, controlling allocation of the channels of the SATA host for the plurality of SATA devices connected to the device interfaces.

Preferably, the semiconductor chip further comprises an exchange interface for exchanging between the device interfaces, so as to perform data transmission and reception with at least one of USB devices.

In accordance with an aspect of the present invention, there is provided a semiconductor system including: a universal serial bus (USB) host; a plurality of USB devices for receiving data from the USB host and storing the data, or transmitting the stored data to the USB host; and a semiconductor chip for controlling data transmission and reception between the USB host and the USB devices, the semiconductor chip including: a USB host interface connected to channels of the USB host through one or more connectors and interfacing data transmission and reception with the USB host; a plurality of device interfaces for interfacing data transmission and reception with the plurality of USB devices; and a USB hub for, when the number of the plurality of USB devices connected to the device interfaces is more than the number of the channels of the USB host, controlling allocation of the channels of the USB host for the plurality of USB devices connected to the device interfaces.

Preferably, the semiconductor chip is a system-on-chip (SoC) storage controller.

In accordance with an aspect of the present invention, there is provided a storage controller including: a USB host interface connected to channels of a USB host through a connector so as to interface data transmission and reception with the USB host; a plurality of device interfaces for receiving data from the USB host and storing the data, or performing interfacing data transmission and reception with a plurality of USB devices for transmitting the stored data to the USB host; and a USB hub for, when the number of the plurality of USB devices connected to the device interfaces is much more than the number of the channels of the USB host, controlling allocation of the channels of the USB host for the plurality of USB devices connected to the device interfaces.

Preferably, the semiconductor chip further comprises exchange interfaces for exchanging between the device interfaces, so as to perform data transmission and reception with at least one of SATA devices.

### Advantageous Effects

A semiconductor chip and a semiconductor system including the same according to the present invention, have merits in that the semiconductor chip may be connected to a plurality of devices without being limited by the number of host channels of the semiconductor chip, while preventing an increase in the size of a host.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a semiconductor chip and a semiconductor system including the same according to an embodiment of the present invention; and

FIGS. 2 to 5 are block diagrams of a semiconductor chip and a semiconductor system including the same according to other embodiments of the present invention.

### MODE FOR CARRYING OUT THE INVENTION

In order to understand purposes achieved by the present invention, an advantage on operations of the present invention, and an embodiment of the present invention, the accompanying drawings and contents contained in the drawings, illustrating an exemplary of an embodiment of the present invention, should be referred to.

Hereinafter, exemplary embodiments of the present invention will be described in detail with reference to the accompanying drawings. The same reference numerals presented in each drawing represent identical members.

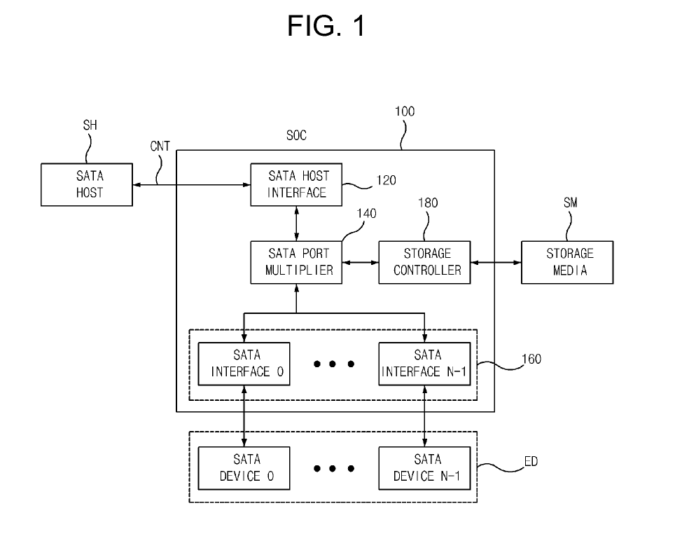

FIG. 1 is a block diagram of a semiconductor chip and a semiconductor system including the same according to an embodiment of the present invention.

Referring to FIG. 1, a semiconductor chip 100 according to an embodiment of the present invention includes a serial advanced technology attachment (SATA) host interface 120, a SATA port multiplier 140, a plurality of device interfaces (SATA interfaces) 160, and a storage controller 180.

The SATA host interface 120 interfaces with a connected SATA host (SH). For example, for data transmission and reception with the SATA host (SH) connected to a connector (CNT), the SATA host interface 120 may perform initial connection settings, data transmission and reception speed settings, and a communication at the time of data transmission and reception.

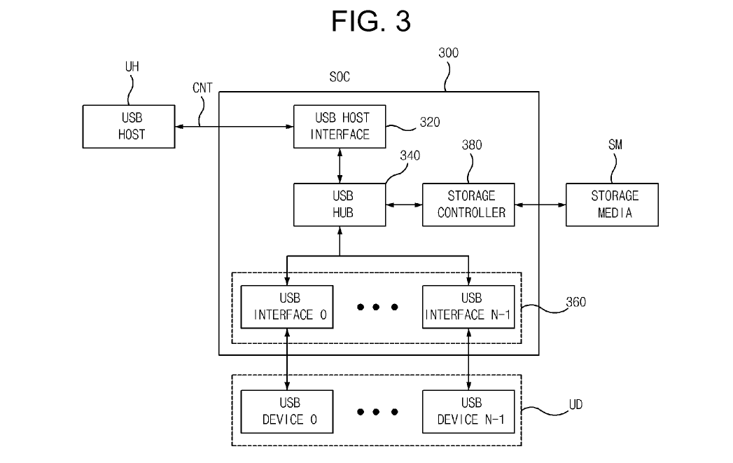

While FIG. 3 illustrates a case in which the semiconductor chip 100 has one connector (CNT), the present invention is not limited thereto. The semiconductor chip 100 according to an embodiment of the present invention may include a plurality of connectors connected with the SATA host (SH).

The SATA host interface 120 transmits or receives data, which is transmitted or received by a plurality of SATA devices (SD) connected through a plurality of device interfaces 160 as described below, from or to the SATA host (SH).

The SATA port multiplier 140 controls allocation of SATA host channels included in the semiconductor chip, the number of which is smaller than the plurality of SATA devices (SD), to the SATA devices (SD).

The SATA port multiplier 140, by a switching scheme such as a FIS based switching scheme, a command based switching scheme or the like, may allocate the plurality of SATA devices (SD) to the SATA host (SH) or may allocate the plurality of SATA devices (SD) according to time. For example, the SATA port multiplier 140 may sequentially allocate the plurality of SATA devices (SD) to the plurality of SATA devices (SD), respectively. The SATA port multiplier 140 may make a control to connect a first SATA device with the connector (CNT) at a first time point and to connect a second SATA device with the connector (CNT) at a second time point.

The SATA port multiplier 140 may include a memory (not shown) for temporarily store or buffering data.

In addition, the SATA port multiplier 140 performs interfacing with each of the plurality of SATA devices (SD) through the plurality of device interfaces (SATA interfaces) 160.

The SATA devices (SD) receive data from the SATA host (SH) and store the data, or may transmit the stored data to the SATA host (SH).

The storage controller 180 controls data transmission and reception with storage media 500 such as a NAND flash memory device, an optical memory device, or the like. Data transmitted from or received by the storage media through the storage controller 180 may be transmitted to a connector 300 by the SATA port multiplier 140. Therefore, the SATA port multiplier 140 as shown in FIG. 3 may further perform switching operations for the storage controller 180.

As described above, since the semiconductor chip according to an embodiment of the present invention includes the SATA port multiplier 140 as a separate chip, the semiconductor chip can connect a plurality of devices to a host without increasing the area of the host device and without being limited by the number of the host channels.

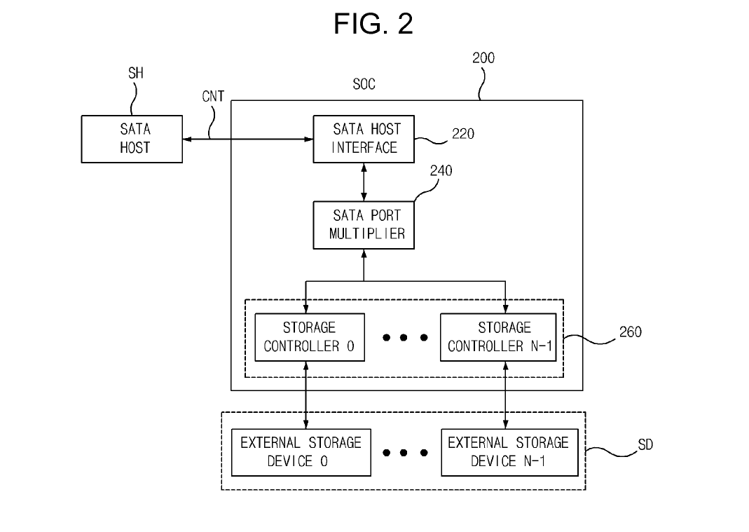

FIG. 2 is a block diagram of a semiconductor chip and a semiconductor system including same according to another embodiment of the present invention.

Referring to FIG. 2, a semiconductor chip 200 of FIG. 2 includes a SATA port multiplier 240 for controlling allocation of SATA host channels, the number of which is smaller than a plurality of SATA devices, to the plurality of SATA devices, as shown in FIG. 1.

However, the semiconductor chip 200 of FIG. 2 includes a plurality of external storage devices SD which communicate using the device interfaces. In this event, the plurality of SATA devices (SD) of FIG. 1 may be external storage devices, such as an HDD, an optical disk, a SSD, or the like.

Therefore, the semiconductor chip 200 of FIG. 2 may include a storage controller 260, which corresponds to the device interfaces 160 of FIG. 1 and performs interfacing with each of the corresponding external storage devices. In this event, the storage controller 180 of FIG. 1 may be one of the storage controllers 260 of FIG. 2.

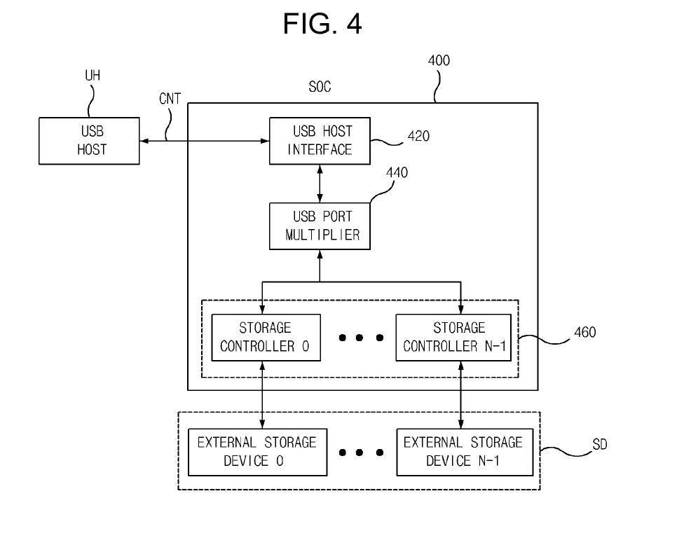

The semiconductor chip (system-on-chip (Soc) storage controller) described above corresponds to an example of allocating the SATA host channels to the external SATA devices, but the present invention is not limited thereto. The semiconductor chip (Soc storage controller) according to an embodiment of the present invention may perform interfacing between hosts and devices, which are connected through interfaces, such as a USB, which is an interface other than the device interfaces, as shown FIGS. 3 and 4.

Referring to FIG. 3 which illustrates a semiconductor chip and a semiconductor system including the same according to another embodiment of the present invention, a semiconductor chip 300 of FIG. 3 includes a universal serial bus (USB) host interface 320, a universal serial bus (USB) hub 340, a plurality of device interfaces (USB interfaces) 360, and a storage controller 380.

The USB host interface 320 performs interfacing with a connected USB host (UH). For example, for data transmission and reception with the USB host (UH) connected to a connector (CNT), the USB host interface 320 may perform initial connection settings, data transmitting and receiving speed settings, and a communication at the time of data transmission and reception.

While FIG. 1 illustrates a case in which the semiconductor chip 300 has one connector (CNT), the present invention is not limited thereto. The semiconductor chip 300 according to an embodiment of the present invention may include a plurality of connectors connected with the USB host (UH).

The USB host interface 320 transmits or receives data, which is transmitted or received by a plurality of USB devices (UD) connected through a plurality of device interfaces 360 located on the outside of the semiconductor chip 300, to or from the USB host (UH).

The USB hub 340 controls allocation of SATA host channels, the number of which is smaller than the plurality of USB devices (UD), to the USB devices (UD).

Since the semiconductor chip 300 of FIG. 3 is similar to the semiconductor chip 100 of FIG. 1 except for the fact that interfacing with external apparatuses (hosts and devices) of the semiconductor chip is performed by a USB protocol, a more detail description thereof is omitted.

Likewise, the semiconductor chip 400 of FIG. 4 is similar to the semiconductor chip 200 of FIG. 2 except for the fact that interfacing with external apparatuses (hosts and devices) of the semiconductor chip is performed by a USB protocol, a more detail description thereof is omitted.

The above description discloses optimum embodiments as shown in the drawings and the specification. However, the disclosed embodiments are used only to describe the present invention and are not used to limit the meaning or the scope of the inventions as defined in the attached claims.

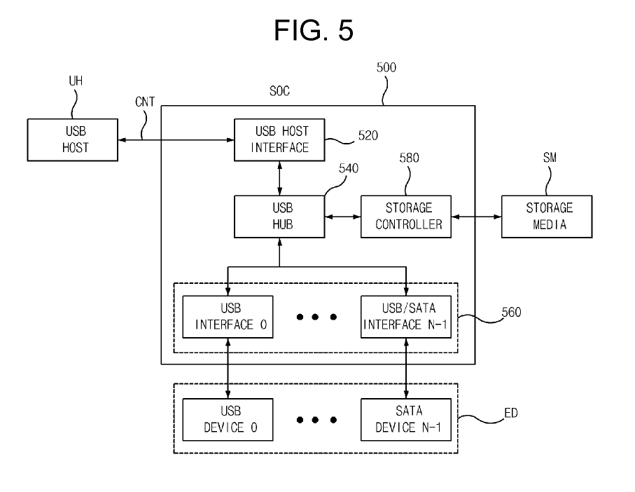

For example, as shown in FIG. 5, a semiconductor system according to another embodiment of the present invention may perform interfacing with external apparatuses which communicate using other interfaces other than one interface.

Referring to FIG. 5, even a semiconductor chip having a USB hub as shown in FIG. 3 or 4 may include an interface (USB/SATA INTERFACE 0) for performing exchange of a USB protocol and a SATA protocol so that the semiconductor chip can perform data transmission or reception with not only an external USB device (USB DEVICE of ED 0) but also a SATA device (SATA DEVICE of ED 0).

Likewise, the semiconductor chip of FIGS. 1 and 2 may include an interface for performing exchange of a USB protocol and a SATA protocol so that the semiconductor chip can perform data transmission or reception with a external USB device other than a SATA device.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A semiconductor system comprising:
a serial advanced technology attachment(SATA) host;
a plurality of SATA devices for receiving data from the SATA host and storing the data, or transmitting the data to the SATA host; and
a semiconductor chip for controlling data transmission and reception between the SATA host and the SATA devices,
the semiconductor chip comprising:
a SATA host interface connected to channels of the SATA host through one or more connectors to perform interfacing data transmission and reception with the SATA host;
a plurality of device interfaces for interfacing data transmission and reception with the plurality of SATA devices; and
a SATA port multiplier for, when the number of the plurality of SATA devices connected to the device interfaces is much more than the number of the channels of the SATA host, controlling allocation of the channels of the SATA host for the plurality of SATA devices connected to the device interfaces.

2. The semiconductor system as claimed in claim 1, wherein the semiconductor chip is a system-on-chip (SoC) storage controller.

3. The system-on-chip (SoC) storage controller comprising:
a SATA host interface for interfacing data transmission and reception with the SATA host by being connected to channels of a SATA host through a connector;
a plurality of device interfaces for receiving data from the SATA host and storing the data, or interfacing data transmission and reception with a plurality of SATA devices for transmitting the data to the SATA host; and
a SATA port multiplier for, when the number of the plurality of SATA devices connected to the device interfaces is more than the number of the channels of the SATA host, controlling allocation of the channels of the SATA host for the plurality of SATA devices connected to the device interfaces.

4. The semiconductor chip as claimed in claim 3, wherein the semiconductor chip further comprises an exchange interface for exchanging between the device interfaces, so as to perform data transmission and reception with at least one of USB devices.

5. A semiconductor system comprising:
a universal serial bus (USB) host;
a plurality of USB devices for receiving data from the USB host and storing the data, or transmitting the stored data to the USB host; and
a semiconductor chip for controlling data transmission and reception between the USB host and the USB devices,
the semiconductor chip comprising:
a USB host interface connected to channels of the USB host through one or more connectors and interfacing data transmission and reception with the USB host;
a plurality of device interfaces for interfacing data transmission and reception with the plurality of USB devices; and
a USB hub for, when the number of the plurality of USB devices connected to the device interfaces is more than the number of the channels of the USB host, controlling allocation of the channels of the USB host for the plurality of USB devices connected to the device interfaces.

6. The semiconductor system as claimed in claim 5, wherein the semiconductor chip is a system-on-chip (SoC) storage controller.

7. The system-on-chip (SoC) storage controller comprising:
a USB host interface connected to channels of a USB host through a connector so as to interface data transmission and reception with the USB host;
a plurality of device interfaces for receiving data from the USB host and storing the data, or performing interfacing data transmission and reception with a plurality of USB devices for transmitting the data to the USB host; and
a USB hub for, when the number of the plurality of USB devices connected to the device interfaces is much more than the number of the channels of the USB host, controlling allocation of the channels of the USB host for the plurality of USB devices connected to the device interfaces.

8. The semiconductor chip as claimed in claim 7, wherein the semiconductor chip further comprises exchange interfaces for exchanging between the device interfaces, so as to perform data transmission and reception with at least one of SATA devices.
